(19) United States
(12) Patent Application Publication
(10) Pub. No.: US 2025/0323739 A1
(43) Pub. Date: Oct. 16, 2025

(54) CELL SELECTION METHOD, USER EQUIPMENT AND STORAGE MEDIUM

(71) Applicant: REALME CHONGQING MOBILE TELECOMMUNICATIONS CORP., LTD., Chongqing (CN)

(72) Inventor: Hanming YANG, Chongqing (CN)

(21) Appl. No.: 19/247,898

(22) Filed: Jun. 24, 2025

Related U.S. Application Data
(63) Continuation of application No. PCT/CN2023/118556, filed on Sep. 13, 2023.

(30) Foreign Application Priority Data
Dec. 27, 2022 (CN) 202211686431.9

(51) Int. Cl. H04B 17/318; H04W 36/00

(52) U.S. Cl. CPC H04B 17/328; H04W 36/0085

(57) ABSTRACT

Provided are a cell selection method, user equipment and a storage medium. In the method, a signal quality of a target cell is measured; and when the signal quality of the target cell is less than a target threshold, cell selection is performed based on a first cell selection criteria, where a minimum access level parameter of the first cell selection criteria is greater than a minimum access level parameter of an initial cell selection criteria.

### CROSS-REFERENCE OF RELATED APPLICATION

This application is a continuation of International Application No. PCT/CN2023/118556 filed Sep. 13, 2023, which claims priority to Chinese Patent Application No. 202211686431.9 filed Dec. 27, 2022, and the entire contents of which are incorporated herein by reference.

### TECHNICAL FIELD

The present disclosure relates to the field of communication technology, and particularly to a cell selection method, user equipment and a storage medium.

### BACKGROUND

In the 3rd Generation Partnership Project (3GPP) protocol, when user equipment performs cell selection, it would camp on a cell as long as the S criterion is met. The user equipment might camp on a cell with poor network signals, resulting in a weak signal for the user equipment.

### SUMMARY

Embodiments of the present disclosure provide a cell selection method, user equipment and a non-transitory computer-readable storage medium.

In a first aspect, the embodiments of the present disclosure provide a cell selection method, and the method includes: measuring a signal quality of a target cell; and in response to the signal quality of the target cell being less than a target threshold, performing cell selection based on a first cell selection criteria, where a minimum access level parameter of the first cell selection criteria is greater than a minimum access level parameter of an initial cell selection criteria.

In a second aspect, the embodiments of the present disclosure provide user equipment including a processor and a memory. The memory is configured to store a computer program including program instructions. The processor is configured to call the program instructions to execute the operations in the first aspect of the embodiments of the present disclosure.

In a third aspect, the embodiments of the present disclosure provide a non-transitory computer-readable storage medium storing a computer program. The computer program causes a computer to execute part or all of the operations described in the first aspect of the embodiments of the present disclosure.

### BRIEF DESCRIPTION OF THE DRAWINGS

In order to more clearly illustrate technical solutions in the embodiments of the present disclosure or technical solutions in the related art, drawings required for the description of the embodiments or drawings required for the description of the related art will be briefly introduced below. Apparently, the drawings described below are only some embodiments of the present disclosure. For those skilled in the art, other drawings can be obtained based on these drawings without paying any creative work.

FIG. 1 a schematic diagram illustrating a network architecture provided in the embodiments of the present disclosure.

FIG. 2 is a schematic flow chart of a cell selection method provided in the embodiments of the present disclosure.

FIG. 3 is a schematic flow chart of another cell selection method provided in the embodiments of the present disclosure.

FIG. 4 is a schematic flow chart of a further cell selection method provided in the embodiments of the present disclosure.

FIG. 5 is a schematic flow chart of a method for selecting an SA cell before improvement as provided in the embodiments of the present disclosure.

FIG. 6 is a schematic flow chart of an improved method for selecting an SA cell as provided in the embodiments of the present disclosure.

FIG. 7 a structural schematic diagram of a cell selection apparatus provided in the embodiments of the present disclosure.

FIG. 8 a structural schematic diagram of user equipment provided in the embodiments of the present disclosure.

### DETAILED DESCRIPTION OF PREFERRED EMBODIMENTS

Terms “first”, “second”, and “third” etc. in the embodiments of the specification, the claims and the drawings of the present disclosure are used to distinguish similar objects and are not necessarily used to describe a specific order or sequence. Furthermore, terms “comprise”, “include” and “have” and any variations thereof, are intended to cover non-exclusive inclusion. For example, a method, system, product, or device including a series of operations or elements is not necessarily limited to those operations or elements expressly listed, but may include other operations or elements not expressly listed or inherent to such process, method, product, or device. Term “and/or” is used to indicate that one or all of two objects associated may be selected. For example, “A and/or B” means A, B, or A+B.

The embodiments of the present disclosure disclose a cell selection method and apparatus, user equipment and a storage medium. In the method, a signal quality of a target cell is measured, and in response to the signal quality of the target cell being less than a target threshold, cell selection is performed based on a first cell selection criteria, where a minimum access level parameter of the first cell selection criteria is greater than a minimum access level parameter of an initial cell selection criteria. When it is measured that the target cell has a poor signal quality, cell selection is performed based on the first cell selection criteria. Compared with the initial cell selection criteria, the minimum access level parameter of the cell selection criteria is increased, which increases the difficulty for the user equipment to camp on the target cell. This avoids the user equipment from camping on a cell with a poor signal quality as much as possible, thereby improving the network signal of a cell where the user equipment camps.

In order to better understand the cell selection method and apparatus, user equipment and storage medium as disclosed in the embodiments of the present disclosure, the network architecture applicable to the embodiments of the present disclosure is first described below. The method disclosed in the embodiments of the present disclosure may be applied to a 5G standalone (SA) system, and may also be applied to other communication systems. In the following, a network architecture applicable to the method as disclosed in the embodiments of the present disclosure is first introduced.

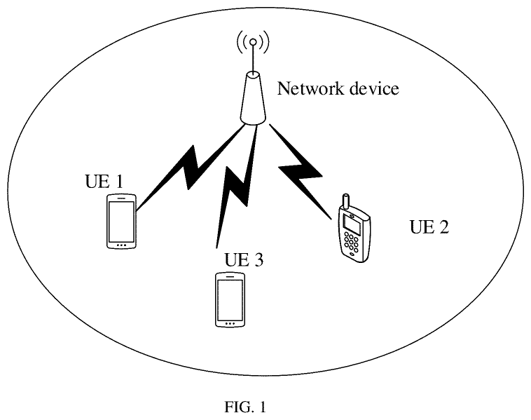

As illustrated in FIG. 1, a schematic diagram of a network architecture provided in the embodiments of the present disclosure is shown. This network architecture is applicable to scenarios where cell selection is required. Specifically, in such scenarios, the signal quality of a target cell is measured, and in response to the signal quality of the target cell being less than a target threshold, cell selection is performed based on a first cell selection criteria, where the minimum access level parameter of the first cell selection criteria is greater than the minimum access level parameter of the initial cell selection criteria.

A cell, also known as a cellular cell, refers to an area covered by a network device or a part of a network device (a sector antenna) in a cellular mobile communication system, within such area user equipment (UE) can communicate reliably with a base station through a wireless channel.

The network device is an entity on the network side for transmitting or receiving signals, such as gNB. User equipment is an entity on the user side for receiving or transmitting signals, such as a mobile phone. Since there are many application scenarios for base stations and UEs, it is illustrated below by taking a case where the base station is a network device as an example. As illustrated in FIG. 1, the network architecture includes a base station and UE (for example, UE 1, UE 2 or UE 3 shown in FIG. 1). The UE in FIG. 1 each may execute the cell selection method as described below.

The target cell is one of areas covered by the base station communicating with the UE. The UE may measure the signal quality of the target cell by interacting with the base station.

The cell selection criteria may also be referred to as S criterion.

During the cell selection, the UE uses the following two search processes.

### (1) Initial Cell Selection

This approach does not require any prior knowledge of a radio channel of the universal telecommunication radio access (UTRA) carrier. The UE searches all radio frequency (RF) channels in the UTRA band. On each carrier, the UE searches for the strongest cell. Then, the UE selects a suitable cell that has been pre-selected and belongs to the public land mobile network (PLMN).

### (2) Cell Selection Based on Stored Information

This approach requires to know some stored carrier frequency information and cell parameters such as scrambling code, which are all obtained from previously measured control information elements. Once the UE finds a suitable cell that belongs to the PLMN, the UE selects this cell.

If no suitable cell is found, the initial cell selection process is initiated.

The initial cell selection criteria is as follows:

$$Srxlev > 0 and Squal > 0 ; \\ Srxlev = Qrxlevmeas - ( Qrxlevmin + Qrxlevminoffset ) - Pcompensation - Qoffsettemp ; \\ and \\ Squal = Qqualmeas - ( Qqualmin + Qqualminoffset ) - Qoffsettemp .$$

Srxlev is a reference signal received power (RSRP) value for cell selection. Squal is a reference signal receievd quality (RSRQ) value for cell selection.

Qrxlevmeas is a measured cell RSRP value, Qqualmeas is a measured cell RSRQ value, Qrxlevmin is the minimum access level parameter (i.e., the minimum RSRP value for access), Qqualmin is a minimum RSRQ value for cell access, Qrxlevminoffse is a minimum RSRP offset value for cell access, and Qqualminoffset is a minimum RSRQ offset value for cell access. Pcompensation is a difference between a maximum transmit power allowed by the network and a maximum transmit power of UE power class. Qoffsettemp is a temporary offset, and Qoffsettemp may be set to 0 or not.

In the existing protocol, the cell selection is performed according to the initial cell selection criteria, in which criteria Qrxlevmin is the minimum RSRP value for access. Qrxlevmin may be obtained from the system information sent by the network device. In the initial cell selection criteria, the minimum access level parameter Qrxlevmin is the cell minimum received level of minimum access channel requirement. If the cell selection is performed using the minimum access level parameter Qrxlevmin of the initial cell selection criteria, the UE might camp on a cell with a poor network signal, resulting in a weak signal of the UE.

In the cell selection method as provided in the embodiments of the present disclosure, when it is measured that the target cell has a poor signal quality, cell selection is performed based on the first cell selection criteria. Compared with the initial cell selection criteria, the minimum access level parameter of the cell selection criteria is increased, which increases the difficulty for the UE to camp on the target cell. This avoids the UE from camping on a cell with a poor signal quality as much as possible, thereby improving the network signal of a cell where the user equipment camps.

The cell selection method as provided in the embodiments of the present disclosure is described in detail below.

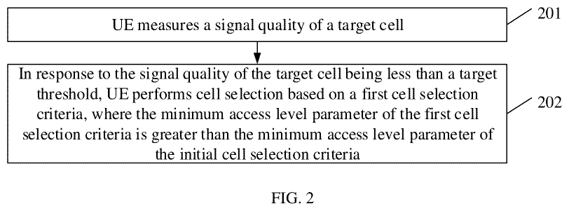

Referring to FIG. 2, a schematic flow chart of a cell selection method provided in the embodiments of the present disclosure is shown. As illustrated in FIG. 2, the cell selection method may include operations 201 and 202 as follows.

At 201, UE measures a signal quality of a target cell.

In the embodiments of the present disclosure, the UE may communicate with a network device and obtains the signal quality of the target cell.

The UE may measure a cell quality based on multi-beam measurement, or may also derive the cell quality based on single-beam measurement (for single-beam cells, or when the UE can only see a single beam of the cell). The UE may also compare the cell qualities measured with different numbers of beams.

The signal quality of the target cell may be a reference signal received quality (RSRQ) of the target cell.

In some implementations, the UE measuring the signal quality of the target cell of operation 201 may include that: the UE measures the reference signal received quality RSRQ of the target cell as the signal quality of the target cell.

The reference signal received quality (RSRQ) is a measurement result on the quality of the wireless network measured by the UE. After the UE reports to the network device, the network device performs resource allocation and selects the modulation method according to the RSRQ of the UE. In 5G new radio (NR), RSRQ may be measured through synchronization signal (SS) or channel state information (CSI). The SS-RSRQ measurement result may be used for cell selection, cell reselection and mobility process, while the CSI-RSRQ measurement may only be used for mobility process.

The RSRQ of the 5G (NR) network may be measured by receiving SS reference signal or CSI reference signal. The RSRQ is measured in dB (decimalism). RSRQ measurement may be used for cell selection, reselection and mobility (handover) processes. RSRQ measurement methods: SS reference signal and CSI reference signal. The RSRQ of 5G network ranges from −43 dB to 20 dB. The RSRQ of the 5G network may be positive or negative.

At 202, in response to the signal quality of the target cell being less than a target threshold, the UE performs cell selection based on a first cell selection criteria, where the minimum access level parameter of the first cell selection criteria is greater than the minimum access level parameter of the initial cell selection criteria.

In the embodiments of the present disclosure, the minimum access level parameter of the initial cell selection criteria may be obtained based on system information sent to the UE. For example, the network device may send system information to the UE, and the system information may carry the minimum access level parameter of the initial cell selection criteria.

The target threshold may be set in advance, or may be determined based on a minimum required RSRQ level included in the system information sent by the network device.

The first cell selection criteria is as follows:

$$Srxlev > 0 and Squal > 0 ; \\ Srxlev = Qrxlevmeas - ( Qrxlevmin\_ 1 + Qrxlevminoffset ) - Pcompensation - Qoffsettemp ; \\ and \\ Squal = Qqualmeas - ( Qqualmin + Qqualminoffset ) - Qoffsettemp .$$

Qrxlevmin_1 of the first cell selection criteria is greater than Qrxlevmin of the initial cell selection criteria. The other parameters of the first cell selection criteria (parameters except Qrxlevmin_1) are the same as the other parameters of the initial cell selection criteria (parameters except Qrxlevmin).

The signal quality of the target cell being less than the target threshold indicates that the signal quality of the target cell is poor. When the signal quality of the target cell is poor, cell selection is performed based on the first cell selection criteria. Since the minimum access level parameter of the first cell selection criteria is greater than the minimum access level parameter of the initial cell selection criteria, the possibility of Srxlev>0 is reduced, and the UE has a low possibility of selecting the target cell, thereby preventing the UE from camping on a cell with a poor signal quality.

In the embodiments of the present disclosure, when it is measured that the target cell has a poor signal quality, cell selection is performed based on the first cell selection criteria. Compared with the initial cell selection criteria, the minimum access level parameter of the cell selection criteria is increased, which increases the difficulty for the UE to camp on the target cell. This avoids the UE from camping on a cell with a poor signal quality as much as possible, thereby improving the network signal of a cell where the UE camps.

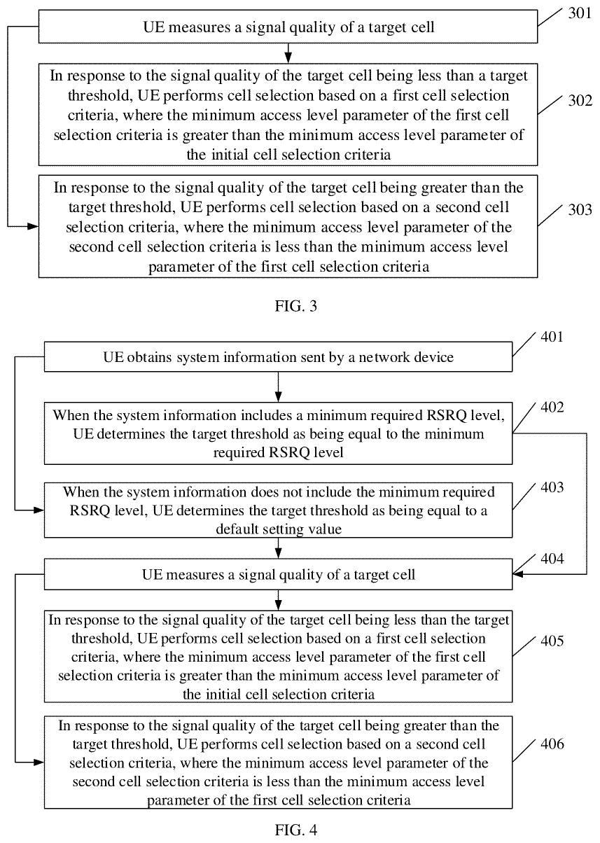

Referring to FIG. 3, a schematic flow chart of another cell selection method provided in the embodiments of the present disclosure is shown. As illustrated in FIG. 3, the cell selection method may include the operations 301-303 as follows.

At 301, UE measures a signal quality of a target cell.

At 302, in response to the signal quality of the target cell being less than a target threshold, the UE performs cell selection based on a first cell selection criteria, where the minimum access level parameter of the first cell selection criteria is greater than the minimum access level parameter of the initial cell selection criteria.

For specific implementations of operations 301 and 302, reference may be made to the relevant description of operations 201 and 202, which will not be repeated here.

At 303, in response to the signal quality of the target cell being greater than the target threshold, the UE performs cell selection based on a second cell selection criteria, where the minimum access level parameter of the second cell selection criteria is less than the minimum access level parameter of the first cell selection criteria.

The second cell selection criteria is as follows.

$$Srxlev > 0 and Squal > 0 ; \\ Srxlev = Qrxlevmeas - ( Qrxlevmin\_ 2 + Qrxlevminoffset ) - Pcompensation - Qoffsettemp ; \\ and \\ Squal = Qqualmeas - ( Qqualmin + Qqualminoffset ) - Qoffsettemp .$$

Qrxlevmin_2 of the second cell selection criteria is less than Qrxlevmin_1 of the first cell selection criteria. The other parameters of the second cell selection criteria (parameters except Qrxlevmin_2) are the same as the other parameters of the first cell selection criteria (parameters except Qrxlevmin_1).

The signal quality of the target cell being greater than the target threshold indicates that the signal quality of the target cell is good. When the signal quality of the target cell is good, the cell selection is performed based on the second cell selection criteria. Since the minimum access level parameter of the second cell selection criteria is less than the minimum access level parameter of the first cell selection criteria, the possibility of Srxlev>0 is increased, and the UE is more likely to select the target cell, thereby increasing the possibility that the UE camps on a cell with a good signal quality.

In the embodiments of the present disclosure, when it is measured that the target cell has a poor signal quality, cell selection is performed based on the first cell selection criteria. Compared with the initial cell selection criteria, the minimum access level parameter of the cell selection criteria is increased, which increases the difficulty for the UE to camp on the target cell. This avoids the UE from camping on a cell with a poor signal quality as much as possible, thereby improving the network signal of a cell where the UE camps. When it is measured that the target cell has a good signal quality, the cell selection is performed based on the second cell selection criteria. Compared with the first cell selection criteria, the minimum access level parameter of the cell selection criteria is reduced, which reduces the difficulty for the UE to camp on the target cell. As such, the possibility that the UE camp on a cell with a good signal quality is increased as much as possible.

Referring to FIG. 4, a schematic flow chart of a further cell selection method provided in the embodiments of the present disclosure is shown. As illustrated in FIG. 4, the cell selection method may include operations 401-406 as follows.

At 401, UE obtains system information sent by a network device.

In the embodiments of the present disclosure, the system information sent by the network device may be system information block (SIB) sent by the base station.

At 402, when the system information includes a minimum required RSRQ level, the UE determines the target threshold as being equal to the minimum required RSRQ level.

At 403, when the system information does not include the minimum required RSRQ level, the UE determines the target threshold as being equal to a default setting value.

In the embodiments of the present disclosure, the system information may include the minimum required RSRQ level, or may not include the minimum required RSRQ level. Whether the system information includes the minimum required RSRQ level is a network behavior.

The default setting value may be preset, and may be stored in a memory (e.g., a non-volatile memory) of the UE.

In the embodiments of the present disclosure, when the system information includes the minimum required RSRQ level, the target threshold is determined to be equal to the minimum required RSRQ level; and when the system information does not include the minimum required RSRQ level, the target threshold is determined to be equal to the default setting value. This provides a criterion for determining the signal quality of the target cell.

Operations 402 and 403 may be performed before operation 405, and operations 402 and 403 may be performed before operation 406.

At 404, the UE measures a signal quality of a target cell.

At 405, in response to the signal quality of the target cell being less than the target threshold, the UE performs cell selection based on a first cell selection criteria, where the minimum access level parameter of the first cell selection criteria is greater than the minimum access level parameter of the initial cell selection criteria.

For the specific implementations of operations 404 and 405, reference may be made to the relevant description of operations 201 and 202, which will not be repeated here.

At 406, in response to the signal quality of the target cell being greater than the target threshold, the UE performs cell selection based on a second cell selection criteria, where the minimum access level parameter of the second cell selection criteria is less than the minimum access level parameter of the first cell selection criteria.

For specific implementation of operation 406, reference may be made to the relevant description of operation 303 above, which will not be repeated here.

In some implementations, the system information further includes the minimum access level parameter of the initial cell selection criteria.

The minimum access level parameter of the first cell selection criteria is a larger one of the minimum access level parameter of the initial cell selection criteria and a first setting value, where the first setting value is greater than the minimum access level parameter of the initial cell selection criteria.

In the embodiments of the present disclosure, the minimum access level parameter of the first cell selection criteria is the larger one of the minimum access level parameter of the initial cell selection criteria and the first setting value. Since the first setting value is greater than the minimum access level parameter of the initial cell selection criteria, the minimum access level parameter of the first cell selection criteria is the first setting value, which can ensure that the minimum access level parameter of the first cell selection criteria is greater than the minimum access level parameter of the initial cell selection criteria.

In some implementations, the minimum access level parameter of the second cell selection criteria is a larger one of the minimum access level parameter of the initial cell selection criteria and a second setting value, where the second setting value is less than the first setting value.

In the embodiments of the present disclosure, the minimum access level parameter of the second cell selection criteria is the larger one of the minimum access level parameter of the initial cell selection criteria and the second setting value. Since the second setting value is less than the first setting value, and the first setting value is greater than the minimum access level parameter of the initial cell selection criteria, it can be ensured that the minimum access level parameter of the second cell selection criteria is less than the minimum access level parameter of the first cell selection criteria. If the second setting value is greater than the minimum access level parameter of the initial cell selection criteria, the minimum access level parameter of the second cell selection criteria is the second setting value; and if the second setting value is less than the minimum access level parameter of the initial cell selection criteria, the minimum access level parameter of the second cell selection criteria is the minimum access level parameter of the initial cell selection criteria.

In some implementations, the target cell includes a standalone SA cell.

The embodiments of the present disclosure may be applied to 5G standalone (SA) cells.

In the following, it is illustrated by taking a case where the target cell includes a standalone SA cell as an example.

Currently, when UE performs cell selection, it would camp on a cell as long as the S criterion is met, regardless of whether the SA network is strong or weak. The UE might camp on a weak SA cell (i.e., a SA cell with a poor network signal).

In a complex network environment, since the SA network deployment is not yet perfect, the network signal of the SA cell is poor in some places. If the network signal of the SA cell is poor but the S criterion is met, the UE would generally camp on the SA cell with the poor network signal. This causes the network signal at the user terminal to be weak.

The embodiments of the present disclosure can solve the SA cell selection problem in complex scenarios. The embodiments of the present disclosure provide a cell selection method. In the cell selection method, if it is determined that a SA cell is relatively weak, a feasible intelligent method is used to prevent the UE from camp on the weak SA cell. If it is determined that the SA cell is relatively strong, the UE is made to camp on the SA cell as much as possible through an intelligent method. It not only increases the SA camp-on success rate, but also avoids UE from camping on weak SA cells.

The S criterion is as follows:

$$Srxlev > 0 and Squal > 0 ; \\ Srxlev = Qrxlevmeas - ( Qrxlevmin + Qrxlevminoffset ) - Pcompensation - Qoffsettemp ; \\ and \\ Squal = Qqualmeas - ( Qqualmin + Qqualminoffset ) - Qoffsettemp .$$

Qrxlevmin is read from the system information SIB1, and it is the minimum access level. In the embodiments of the present disclosure, the value of Qrxlevmin may be customized, specifically, max (SIB1-q-RxLevMin, Qrxlevmin_setting) is taken for Qrxlevmin which is a larger one of SIB 1-q-RxLevMin and Qrxlevmin_setting. SIB1-q-RxLevMin is the minimum access level parameter read from the system information SIB1.

The UE may set three values, RSRQ_TH, Qrxlevmin_weak, and Qrxlevmin_strong.

RSRQ_TH is a threshold. If there is q-QualMin (i.e., the minimum required RSRQ level) in the system information SIB1, RSRQ_TH is equal to q-QualMin.

If there is no q-QualMin in the system information SIB1, RSRQ_TH is a value set by the terminal by default (i.e., a default setting value).

The UE measures the RSRQ of the target cell (the signal quality of the target cell), which may be referred to as target_RSRQ.

If target_RSRQ<RSRQ_TH, Qrxlevmin_setting is assigned as Qrxlevmin_weak, and the minimum access level Qrxlevmin is increased. If the RSRQ of the target cell is relatively poor, the minimum access level is increased, which prevents the UE from camping on the weak SA cell.

If target_RSRQ>RSRQ_TH, Qrxlevmin_setting is assigned as Qrxlevmin_strong, and the minimum access level Qrxlevmin is reduced relative to the case where target_RSRQ<RSRQ_TH. If the target cell RSRQ is good, the minimum access level is lowered relative to the case where target_RSRQ<RSRQ_TH. This allows the UE to camp on the SA cell as much as possible.

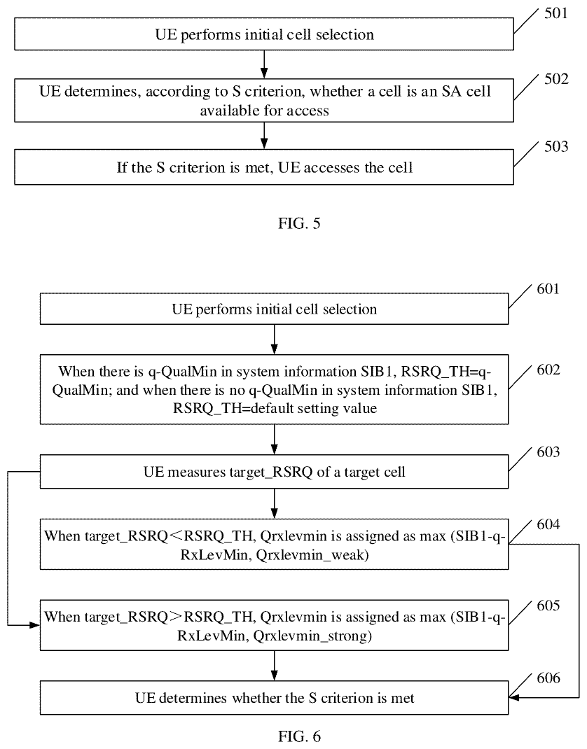

Referring to FIG. 5, a schematic flow chart of a method for selecting an SA cell before improvement as provided in the embodiments of the present disclosure is shown. As illustrated in FIG. 5, the method includes operations 501-503 as follows.

At 501, the UE performs initial cell selection.

At 502, the UE determines, according to the S criterion, whether a cell is an SA cell available for access.

At 503, if the S criterion is met, the UE accesses the cell.

Referring to FIG. 6, a schematic flow chart of an improved method for selecting an SA cell provided in the embodiments of the present disclosure is shown. As illustrated in FIG. 6, the method includes operations 601-606 as follows.

At 601, the UE performs initial cell selection.

The UE sets three values, RSRQ_TH, Qrxlevmin_weak, and Qrxlevmin_strong.

At 602, when there is q-QualMin in the system information SIB1, RSRQ_TH=q-QualMin; and when there is no q-QualMin in the system information SIB1, RSRQ_TH=a default setting value.

At 603, the UE measures target_RSRQ of a target cell.

At 604, when target_RSRQ<RSRQ_TH, Qrxlevmin is assigned as max (SIB1-q-RxLevMin, Qrxlevmin_weak).

At 605, when target_RSRQ>RSRQ_TH, Qrxlevmin is assigned as max (SIB1-q-RxLevMin, Qrxlevmin_strong).

At 606, the UE determines whether the S criterion is met.

By executing operations 604 and 606, the UE can eventually be prevented from camping on a weak SA cell; and by executing operations 605 and 606, the UE can camp on the SA cell as much as possible.

As be seen from FIG. 5 and FIG. 6, through improvements of the embodiments of the present disclosure, the camp-on success rate of 5G terminals in camping on SA cells and the user perceived signals are all greatly improved, which enhances the user experience. When the SA cell is good, the terminal may camp on the SA cell as much as possible. When the SA cell is relatively weak, the terminal may be prevented from camping on the weak SA cell, and may camp on a strong cell.

For example, the UE sets values as follows: RSRQ_TH is set to −10 db, Qrxlevmin_strong is set to −116 dbm, and Qrxlevmin_weak is set to −110 dbm.

In a first case, assuming that there is q-QualMin in the system information SIB1 sent by the network device, and the UE obtains that q-QualMin is −12 db, RSRQ_TH is reassigned as q-QualMin, i.e., −12 db. The UE obtains that SIB1-q-RxLevMin in the system information SIB1 is −128 dbm.

1. If the UE measures that the RSRQ of the target cell is −7 db, target_RSRQ =−7.

Since target_RSRQ>RSRQ_TH, i.e., −7>−12 (that is, the RSRQ of the target cell is good, and the signal quality of the target cell is good), the Qrxlevmin_setting is assigned as Qrxlevmin_strong=−116 dbm.

Qrxlevmin takes a larger one of SIB1-q-RxLevMin and Qrxlevmin_setting, that is, max(SIB1-q-RxLevMin, Qrxlevmin_setting) is taken for Qrxlevmin. As such, Qrxlevmin takes max(−128,−116), i.e., Qrxlevmin is −116. That is, the UE reduces the minimum access level relative to the case where target_RSRQ<RSRQ_TH described below.

The S criterion in the protocol is as follows: Srxlev>0 and Squal>0, Srxlev=Qrxlevmeas−(Qrxlevmin+Qrxlevminoffset)−Pcompensation−Qoffsettemp. As Qrxlevmin is decreased relative to the case where target_RSRQ<RSRQ_TH, the probability of Srxlev>0 is increased. In addition, the Qrxlevmin is maintained or increased relative to a case where the cell selection is performed using the minimum access level parameter of the initial cell selection criteria, Srxlev is decreased for other cells with a lower signal quality than the currently measured cell. That is, the cell measured by the UE is made to meet the S criterion as much as possible, and the UE is made to camp on the SA cell as much as possible.

2. If the UE measures that the RSRQ of the target cell is −14 db, target_RSRQ=−14.

Since target_RSRQ<RSRQ_TH, i.e., −14<−12 (that is, the RSRQ of the target cell is relatively poor, and the signal quality of the target cell is relatively poor), Qrxlevmin_setting is assigned as Qrxlevmin_weak=−110 dbm.

Qrxlevmin takes a larger one of SIB1-q-RxLevMin and Qrxlevmin_setting, that is, max(SIB1-q-RxLevMin, Qrxlevmin_setting) is taken for Qrxlevmin. As such, Qrxlevmin takes max(−128,−110), i.e., Qrxlevmin is−110. That is, the UE increases the minimum access level.

The S criterion in the protocol is as follows: Srxlev>0 and Squal>0, Srxlev=Qrxlevmeas−(Qrxlevmin+Qrxlevminoffset)−Pcompensation−Qoffsettemp. As Qrxlevmin is increased, Srxlev is decreased. The probability of Srxlev>0 is also reduced. That is, the cell measured by the UE is made to not meet the S criterion as much as possible, and the UE is prevented from camping on the SA cell as much as possible.

In a second case, assuming that there is no q-QualMin in the system information SIB1, RSRQ_TH is the default value −10 db set by the UE. The UE obtains that SIB1-q-RxLevMin in the system information SIB1 is −128 dbm.

1. If the UE measures that the RSRQ of the target cell is −7 db, target_RSRQ=−7.

Since target_RSRQ>RSRQ_TH, i.e., −7>−10 (that is, the RSRQ of the target cell is good, and the signal quality of the target cell is good), Qrxlevmin_setting is assigned as Qrxlevmin_strong=−116 dbm.

Qrxlevmin takes a larger one of SIB1-q-RxLevMin and Qrxlevmin_setting, that is, max(SIB1-q-RxLevMin, Qrxlevmin_setting) is taken for Qrxlevmin. As such, Qrxlevmin takes max(−128, −116), i.e., Qrxlevmin is −116. That is, the UE reduces the minimum access level relative to the case where target_RSRQ<RSRQ_TH described below.

The S criterion in the protocol is as follows: Srxlev>0 and Squal>0, Srxlev=Qrxlevmeas−(Qrxlevmin+Qrxlevminoffset)−Pcompensation−Qoffsettemp. As Qrxlevmin is decreased relative to the case where target_RSRQ<RSRQ_TH, the probability of Srxlev>0 is increased. In addition, the Qrxlevmin is maintained or increased relative to a case where the cell selection is performed using the minimum access level parameter of the initial cell selection criteria, Srxlev is decreased for other cells with a lower signal quality than the currently measured cell. That is, the cell measured by the UE is made to meet the S criterion as much as possible, and the UE is made to camp on the SA cell as much as possible.

2. If the UE measures that the RSRQ of the target cell is −14 db, target_RSRQ=−14.

Since target_RSRQ<RSRQ_TH, i.e., −14<−10 (that is, the RSRQ of the target cell is relatively poor, and the signal quality of the target cell is relatively poor), the Qrxlevmin_setting is assigned as Qrxlevmin_weak=−110 dbm.

Qrxlevmin takes a larger one of SIB1-q-RxLevMin and Qrxlevmin_setting, that is, max(SIB1-q-RxLevMin, Qrxlevmin_setting) is taken for Qrxlevmin. As such, Qrxlevmin takes max(−128, −110), i.e., Qrxlevmin is −110. That is, the UE increases the minimum access level.

The S criterion in the protocol is as follows: Srxlev>0 and Squal>0, Srxlev=Qrxlevmeas−(Qrxlevmin+Qrxlevminoffset)−Pcompensation−Qoffsettemp. As Qrxlevmin is increased, Srxlev is decreased. The probability of Srxlev>0 is also reduced. That is, the cell measured by the user equipment is made to not meet the S criterion as much as possible, and the UE is prevented from camping the SA cell as much as possible.

The foregoing mainly introduces solutions of the embodiments of the present disclosure from the perspective of the execution process of the methods. It is understandable that, in order to implement the above functions, the UE includes hardware structures and/or software modules executing individual corresponding functions. Those skilled in the art should readily appreciate that, in combination with the units and algorithm operations of the various examples described in the embodiments provided herein, the present disclosure may be implemented in the form of hardware or a combination of hardware and computer software. Whether a function is performed by hardware or by computer software which drives hardware depends on the specific application and design constraints of the technical solution. Professional technicians may use different methods to implement the described functions for each specific application, but such implementation should not be considered as going beyond the scope of the present disclosure.

The embodiments of the present disclosure may divide the functional units of the UE according to the above method examples. For example, functional units may be divided according to the individual functions, or two or more functions may be integrated into one processing unit. The integrated unit may be implemented in the form of hardware or software functional unit. It is notable that the division of units in the embodiments of the present disclosure is exemplary, and it is merely division in terms of logical functions. There may be other division methods in actual implementations.

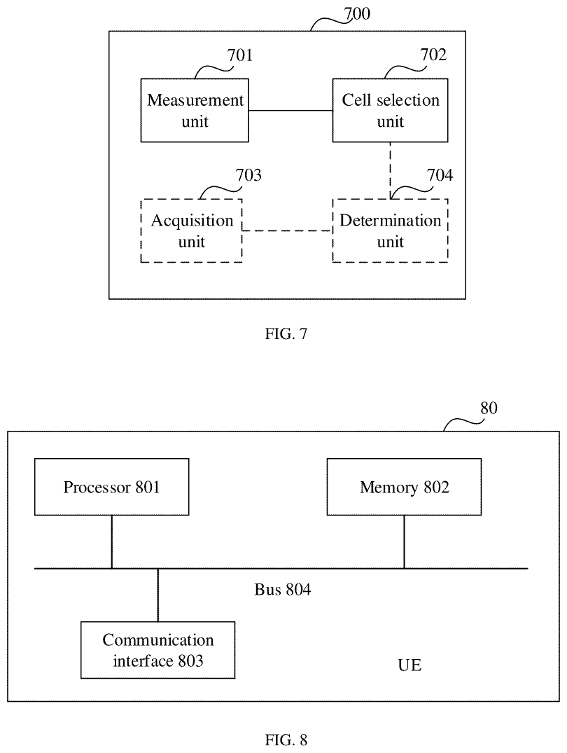

As illustrated in FIG. 7, a structural schematic diagram of a cell selection apparatus provided in the embodiments of the present disclosure is shown. The cell selection apparatus 700 may include a measurement unit 701 and a cell selection unit 702.

The measurement unit 701 is configured to measure a signal quality of a target cell.

The cell selection unit 702 is configured to perform cell selection based on a first cell selection criteria in response to the signal quality of the target cell being less than a target threshold, where the minimum access level parameter of the first cell selection criteria is greater than the minimum access level parameter of the initial cell selection criteria.

In some implementations, the cell selection unit 702 is further configured to perform the cell selection based on a second cell selection criteria in response to the signal quality of the target cell being greater than the target threshold, where the minimum access level parameter of the second cell selection criteria is less than the minimum access level parameter of the first cell selection criteria.

In some implementations, regarding measurement of the signal quality of the target cell, the measurement unit 701 is configured to measure a reference signal received quality RSRQ of the target cell as the signal quality of the target cell.

In some implementations, the cell selection apparatus 700 may further include an acquisition unit 703 and a determination unit 704.

The acquisition unit 703 is configured to acquire system information sent by a network device.

The determination unit 704 is configured to determine, when the system information includes a minimum required RSRQ level, that the target threshold is equal to the minimum required RSRQ level.

The determining unit 704 is further configured to determine, when the system information does not include the minimum required RSRQ level, that the target threshold is equal to a default setting value.

In some implementations, the system information may further include the minimum access level parameter of the initial cell selection criteria.

The minimum access level parameter of the first cell selection criteria is a larger one of the minimum access level parameter of the initial cell selection criteria and a first setting value, where the first setting value is greater than the minimum access level parameter of the initial cell selection criteria.

In some implementations, the minimum access level parameter of the second cell selection criteria is a larger one of the minimum access level parameter of the initial cell selection criteria and a second setting value, where the second setting value is less than the first setting value.

In some implementations, the target cell includes a standalone SA cell.

The measurement unit 701, the cell selection unit 702, and the determination unit 704 may be a processor in the UE. The acquisition unit 703 may be a communication interface in the UE.

In the embodiments of the present disclosure, when it is measured that the target cell has a poor signal quality, cell selection is performed based on the first cell selection criteria. Compared with the initial cell selection criteria, the minimum access level parameter of the cell selection criteria is increased, which increases the difficulty for the UE to camp on the target cell. This avoids the UE from camping on a cell with a poor signal quality as much as possible, thereby improving the network signal of a cell where the user equipment camps.

It is understandable that the division of the various units of the cell selection apparatus in FIG. 7 is merely division in terms of logical functions, and in actual implementations, they may be all or partially integrated into one physical entity, or may be physically separated. For example, the above units may be discrete processing elements, or they may be integrated into a chip of the terminal. In addition, they may be stored in a storage element of a controller in the form of program codes, and called by a processing element of the processor to execute the functions of the above units. In addition, the individual units may be integrated together or implemented independently. The processing element here may be an integrated circuit chip having the capability of processing signals. In the implementation process, each operation of the above method or each unit above may be implemented by a physical integrated logic circuit in the processing element or instructions in the form of software. The processing element may be a general-purpose processor, such as a network processor or a central processing unit (CPU), or may be one or more integrated circuits configured to implement the above methods, such as one or more application-specific integrated circuits (ASICs), or one or more digital signal processors (DSPs), or one or more field-programmable gate arrays (FPGAs).

FIG. 8 is a structural schematic diagram of UE provided in the embodiments of the present disclosure. As illustrated in FIG. 8, the UE 80 includes a processor 801, a memory 802, and a communication interface 803. The processor 801, the memory 802, and the communication interface 803 are interconnected via a bus 804. The UE in FIG. 8 may be a first communication node in the aforementioned embodiments.

The memory 802 includes, but is not limited to, random access memory (RAM), read-only memory (ROM), erasable programmable read-only memory (EPROM), or compact disk read-only memory (CDROM). The memory 802 is configured for related instructions and data. The communication interface 803 is configured to receive and send data.

The processor 801 may be a general-purpose central processing unit (CPU), a microprocessor, an application specific integrated circuit (ASIC) or one or more integrated circuits, and is configured to execute relevant programs to implement the cell selection methods provided in the aforementioned embodiments. The processor 801 may implement the functions of the measurement unit 701, the cell selection unit 702, and the determination unit 704 shown in FIG. 7.

The processor 801 may also be an integrated circuit chip having the capability of processing signals. During implementation, each operation of the cell selection methods of the present disclosure may be implemented by a physical integrated logic circuit in the processor 801 or by instructions in the form of software. The processor 801 may also be a general-purpose processor, a digital signal processor (DSP), an application-specific integrated circuit (ASIC), a field programmable gate array (FPGA) or other programmable logic devices, discrete gate or transistor logic devices, and discrete hardware components. It may implement or execute the various methods, operations and logic diagrams disclosed in the embodiments of the present disclosure. The general purpose processor may be a microprocessor, or any conventional processor or the like. The operations of the methods as disclosed in the embodiments of the present disclosure may be directly implemented as being executed by a hardware decoding processor, or may be implemented by a combination of hardware in the decoding processor and software modules. The software module may be located in a random access memory, a flash memory, a read-only memory, a programmable read-only memory, an electrically erasable programmable memory, a register, or other mature storage media in the art. The storage medium is located in the memory 802, and the processor 801 reads information from the memory 802, and combines its hardware to implement the cell selection methods provided in the embodiments of the present disclosure and communications.

The communication interface 803 uses, but is not limited to, a receiving and transmitting means such as a transceiver to implement communication between the UE 80 and other devices or a communication network. The bus 804 may include a path for transmitting information between various components of the UE 80 (e.g., the memory 802, the processor 801, and the communication interface 803). The communication interface 803 may implement the function of the acquisition unit 703 shown in FIG. 7.

The processor 801 in the UE 80 is configured to read program codes stored in the memory 802 to implement the cell selection methods as provided in the above embodiments.

In the embodiments of the present disclosure, when it is measured that the target cell has a poor signal quality, cell selection is performed based on the first cell selection criteria. Compared with the initial cell selection criteria, the minimum access level parameter of the cell selection criteria is increased, which increases the difficulty for the UE to camp on the target cell. This avoids the UE from camping on a cell with a poor signal quality as much as possible, thereby improving the network signal of a cell where the UE camps.

The embodiments of the present disclosure further provide a computer storage medium. The computer storage medium stores a computer program for electronic data exchange, and the computer program causes a computer to execute part or all of the operations of any cell selection method provided in the above method embodiments.

The embodiments of the present disclosure further provide a computer program product. The computer program product includes a non-transitory computer-readable storage medium storing a computer program, and the computer program causes a computer to execute part or all of the operations of any cell selection method provided in the above method embodiments.

It is notable that, for the sake of simplicity of description, the aforementioned method embodiments are all expressed as a series of action combinations, but those skilled in the art should know that the present disclosure is not limited to the described order of actions, because some operations may be performed in other orders or simultaneously according to the present disclosure. Second, those skilled in the art should also be aware that the embodiments described in the specification are all preferred embodiments, and the actions and modules involved are not necessarily required by the present disclosure.

In the above embodiments, the description of each embodiment has its own emphasis. For parts that are not described in detail in a certain embodiment, reference may be made to the relevant descriptions of other embodiments.

In several embodiments as provided in the present disclosure, it is understandable that the disclosed apparatus may be implemented in other ways. For example, the apparatus embodiments described above are merely illustrative. For example, the division of the units is merely division in terms of logical functions. There may be other division methods in actual implementations. For example, multiple units or components may be combined or integrated into another system, or some features may be ignored or not executed. Furthermore, the mutual coupling or direct coupling or communication connection shown or discussed may be an indirect coupling or communication connection through some interface, means or unit, which may be electrical or in other forms.

The units described as separate components may or may not be physically separated, and the components shown as units may or may not be physical units, that is, they may be located in one place or distributed over multiple network units. Some or all of the units may be selected according to actual needs to achieve the purpose of the solutions of the embodiments.

In addition, the individual functional units in each embodiment of the present disclosure may be integrated into one processing unit, or each unit may exist physically separately, or two or more units may be integrated into one unit. The integrated unit may be implemented in the form of hardware or in the form of a software program module.

If the integrated unit is implemented in the form of a software program module and sold or used as an independent product, it may be stored in a computer-readable memory. Based on this understanding, technical solutions of the present disclosure, or the part that contributes to the prior art, or all or part of technical solutions may be embodied in the form of a software product. The computer software product is stored in a memory and includes a number of instructions for enabling a computer device (which may be a personal computer, server or network device, etc.) to execute all or part of the operations of the method described in each embodiment of the present disclosure. The aforementioned memory includes: U disk, read-only memory (ROM), random access memory (RAM), mobile hard disk, magnetic disk or compact disk and other media that can store program codes.

Those of ordinary skill in the art may understand that all or part of the operations in various methods of the above embodiments may be implemented by instructing related hardware through a program, and the program may be stored in a computer-readable memory. The memory may include: a flash drive, a read-only memory, a random access memory, a magnetic disk or an optical disk, etc.

The embodiments of the present disclosure are introduced in detail above. Specific examples are used herein to illustrate the principles and implementations of the present disclosure. The description of the above embodiments is only used to help understand the methods and core idea of the present disclosure. In addition, for those of ordinary skill in the art, they may change the specific implementations and applications according to the idea of the present disclosure. In summary, the contents of the specification should not be understood as limiting the present disclosure.

What is claimed is:

1. A cell selection method, comprising:
measuring a signal quality of a target cell; and
in response to the signal quality of the target cell being less than a target threshold, performing cell selection based on a first cell selection criteria, wherein a minimum access level parameter of the first cell selection criteria is greater than a minimum access level parameter of an initial cell selection criteria.

2. The method as claimed in claim 1, further comprising:
in response to the signal quality of the target cell being greater than the target threshold, performing the cell selection based on a second cell selection criteria, wherein a minimum access level parameter of the second cell selection criteria is less than the minimum access level parameter of the first cell selection criteria.

3. The method as claimed in claim 1, wherein measuring the signal quality of the target cell comprises:
measuring a reference signal received quality (RSRQ) of the target cell as the signal quality of the target cell.

4. The method as claimed in claim 1, further comprising:
obtaining system information sent by a network device;
in response to the system information comprising a minimum required RSRQ level, determining the target threshold as being equal to the minimum required RSRQ level;
in response to the system information not comprising the minimum required RSRQ level, determining the target threshold as being equal to a default setting value.

5. The method as claimed in claim 4, wherein the system information further comprises the minimum access level parameter of the initial cell selection criteria;
the minimum access level parameter of the first cell selection criteria is a larger one of the minimum access level parameter of the initial cell selection criteria and a first setting value, wherein the first setting value is greater than the minimum access level parameter of the initial cell selection criteria.

6. The method as claimed in claim 5, wherein the minimum access level parameter of the second cell selection criteria is a larger one of the minimum access level parameter of the initial cell selection criteria and a second setting value, the second setting value being less than the first setting value.

7. The method as claimed in claim 1, wherein the target cell comprises a standalone (SA) cell.

8. The method as claimed in claim 2, wherein the initial cell selection criteria comprises:
$$Srxlev > 0 and Squal > 0 ; \\ Srxlev = Qrxlevmeas - ( Qrxlevmin + Qrxlevminoffset ) - Pcompensation - Qoffsettemp ; \\ and \\ Squal = Qqualmeas - ( Qqualmin + Qqualminoffset ) - Qoffsettemp ;$$
where Srxlev is a reference signal received power (RSRP) value for cell selection, and Squal is a reference signal received quality (RSRQ) value for cell selection;
Qrxlevmeas is a measured cell RSRP value, Qqualmeas is a measured cell RSRQ value, Qrxlevmin is the minimum access level parameter, Qqualmin is a minimum RSRQ value for cell access, Qrxlevminoffse is a minimum RSRP offset value for cell access, Qqualminoffset is a minimum RSRQ offset value for cell access, Pcompensation is a difference between a maximum transmit power allowed by a network and a maximum transmit power of user equipment power class, and Qoffsettemp is a temporary offset.

9. The method as claimed in claim 8, wherein the first cell selection criteria comprises:
$$Srxlev > 0 and Squal > 0 ; \\ Srxlev = Qrxlevmeas - ( Qrxlevmin\_ 1 + Qrxlevminoffset ) - Pcompensation - Qoffsettemp ; \\ and \\ Squal = Qqualmeas - ( Qqualmin + Qqualminoffset ) - Qoffsettemp ;$$
where Qrxlevmin_1 of the first cell selection criteria is greater than Qrxlevmin of the initial cell selection criteria, and other parameters of the first cell selection criteria except Qrxlevmin_1 are the same as other parameters of the initial cell selection criteria except Qrxlevmin.

10. The method as claimed in claim 9, wherein the second cell selection criteria comprises:
$$Srxlev > 0 and Squal > 0 ; \\ Srxlev = Qrxlevmeas - ( Qrxlevmin\_ 2 + Qrxlevminoffset ) - Pcompensation - Qoffsettemp ; \\ and \\ Squal = Qqualmeas - ( Qqualmin + Qqualminoffset ) - Qoffsettemp ;$$
where Qrxlevmin_2 of the second cell selection criteria is less than Qrxlevmin_1 of the first cell selection criteria, and other parameters of the second cell selection criteria except Qrxlevmin_2 are the same as other parameters of the first cell selection criteria except Qrxlevmin_1.

11. User equipment, comprising a processor and a memory, wherein the memory is configured to store a computer program comprising program instructions, and the processor is configured to call the program instructions to:
measure a signal quality of a target cell; and
in response to the signal quality of the target cell being less than a target threshold, perform cell selection based on a first cell selection criteria, wherein a minimum access level parameter of the first cell selection criteria is greater than a minimum access level parameter of an initial cell selection criteria.

12. The user equipment as claimed in claim 11, wherein the processor is further configured to:
in response to the signal quality of the target cell being greater than the target threshold, perform the cell selection based on a second cell selection criteria, wherein a minimum access level parameter of the second cell selection criteria is less than the minimum access level parameter of the first cell selection criteria.

13. The user equipment as claimed in claim 11, wherein a reference signal received quality (RSRQ) of the target cell is measured as the signal quality of the target cell, and the target cell comprises a standalone (SA) cell.

14. The user equipment as claimed in claim 11, wherein the processor is further configured to:
obtain system information sent by a network device;
in response to the system information comprising a minimum required RSRQ level, determine the target threshold as being equal to the minimum required RSRQ level;
in response to the system information not comprising the minimum required RSRQ level, determine the target threshold as being equal to a default setting value.

15. The user equipment as claimed in claim 14, wherein the system information further comprises the minimum access level parameter of the initial cell selection criteria;
the minimum access level parameter of the first cell selection criteria is a larger one of the minimum access level parameter of the initial cell selection criteria and a first setting value, the first setting value being greater than the minimum access level parameter of the initial cell selection criteria.

16. The user equipment as claimed in claim 15, wherein the minimum access level parameter of the second cell selection criteria is a larger one of the minimum access level parameter of the initial cell selection criteria and a second setting value, the second setting value being less than the first setting value.

17. The user equipment as claimed in claim 12, wherein the initial cell selection criteria comprises:
$$Srxlev > 0 and Squal > 0 ; \\ Srxlev = Qrxlevmeas - ( Qrxlevmin + Qrxlevminoffset ) - Pcompensation - Qoffsettemp ; \\ and \\ Squal = Qqualmeas - ( Qqualmin + Qqualminoffset ) - Qoffsettemp ;$$
where Srxlev is a reference signal received power (RSRP) value for cell selection, and Squal is a reference signal received quality (RSRQ) value for cell selection;
Qrxlevmeas is a measured cell RSRP value, Qqualmeas is a measured cell RSRQ value, Qrxlevmin is the minimum access level parameter, Qqualmin is a minimum RSRQ value for cell access, Qrxlevminoffse is a minimum RSRP offset value for cell access, Qqualminoffset is a minimum RSRQ offset value for cell access, Pcompensation is a difference between a maximum transmit power allowed by a network and a maximum transmit power of user equipment power class, and Qoffsettemp is a temporary offset.

18. The user equipment as claimed in claim 17, wherein the first cell selection criteria comprises:
$$Srxlev > 0 and Squal > 0 ; \\ Srxlev = Qrxlevmeas - ( Qrxlevmin\_ 1 + Qrxlevminoffset ) - Pcompensation - Qoffsettemp ; \\ and \\ Squal = Qqualmeas - ( Qqualmin + Qqualminoffset ) - Qoffsettemp ;$$
where Qrxlevmin_1 of the first cell selection criteria is greater than Qrxlevmin of the initial cell selection criteria, and other parameters of the first cell selection criteria except Qrxlevmin_1 are the same as other parameters of the initial cell selection criteria except Qrxlevmin.

19. The user equipment as claimed in claim 18, wherein the second cell selection criteria comprises:
$$Srxlev > 0 and Squal > 0 ; \\ Srxlev = Qrxlevmeas - ( Qrxlevmin\_ 2 + Qrxlevminoffset ) - Pcompensation - Qoffsettemp ; \\ and \\ Squal = Qqualmeas - ( Qqualmin + Qqualminoffset ) - Qoffsettemp ;$$
where Qrxlevmin_2 of the second cell selection criteria is less than Qrxlevmin_1 of the first cell selection criteria, and other parameters of the second cell selection criteria except Qrxlevmin_2 are the same as other parameters of the first cell selection criteria except Qrxlevmin_1.

20. A non-transitory computer-readable storage medium storing a computer program thereon, wherein the computer program comprises program instructions which, when being executed by a processor, cause the processor to:
measure a signal quality of a target cell; and
in response to the signal quality of the target cell being less than a target threshold, perform cell selection based on a first cell selection criteria, wherein a minimum access level parameter of the first cell selection criteria is greater than a minimum access level parameter of an initial cell selection criteria.
